(19) United States
(12) Patent Application Publication
(10) Pub. No.: US 2026/0358300 A1
(43) Pub. Date: Nov. 12, 2026

(54) ANGLE BEAM CALIBRATION FOR WORKPIECE INSPECTION

(71) Applicant: Evident Canada, Inc., Quebec (CA)

(72) Inventor: Vincent Bouliane, Québec (CA)

(73) Assignee: Evident Canada, Inc., Quebec (CA)

(21) Appl. No.: 19/672,860

(22) Filed: May 11, 2026

Related U.S. Application Data
(60) Provisional application No. 63/802,803, filed on May 9, 2025.

(51) Int. Cl. G01N 29/30; G01N 29/04; G01N 29/24; G01N 29/26; G01N 29/44

(52) U.S. Cl. CPC G01N 29/30; G01N 29/2487; G01N 29/262; G01N 29/4463; G01N 29/043; G01N 2291/0289

(57) ABSTRACT

An ultrasonic inspection system and method capable of inspecting workpieces of varying cross-sectional sizes are disclosed. A calibration body may have reference reflectors formed at a substantially uniform depth below at least one exterior surface of the calibration body, and the reference reflectors may be positionable relative to an ultrasonic probe in a beam uniformization position and a Time Compensated Gain (TCG) generation position. In the TCG generation position, different angle-beam ultrasonic pulses of an array intersect respective reference reflectors at different depths within the calibration body. A control circuit may generate a TCG curve by aggregating peak amplitude responses at their respective depths and normalize the TCG curve relative to a cross-sectional dimension of the calibration body. The normalized TCG curve can be applied to inspection of test workpieces of different cross-sectional sizes by rescaling normalized depth values in proportion to the cross-sectional dimension of the test workpiece.

### CROSS REFERENCE TO RELATED APPLICATION

This application claims the benefit of priority under 35 U.S.C. § 119(e) to U.S. Provisional Patent Application No. 63/802,803, titled BAR INSPECTION ANGLE BEAM CALIBRATION, filed on May 9, 2025, the entire disclosure of which is hereby incorporated by reference in its entirety.

### BACKGROUND

### Technical Field

This document pertains generally, but not by way of limitation, to non-destructive evaluation, and more particularly, to apparatus and techniques for performing acoustic inspection using a calibration technique to facilitate inspection of workpiece structures, such as supporting inspection of workpieces having different cross-sectional sizes.

### Discussion of Art

Non-destructive testing (NDT) (also referred to as non-destructive inspection) can refer to use of one or more different techniques to inspect regions on or within an object, such as to ascertain whether flaws or defects exist, or to otherwise characterize the object being inspected. Examples of non-destructive test approaches include use of an acoustic inspection technique, such as where one or more electroacoustic transducers are used to insonify a region on or within the object under test, and acoustic energy that is scattered or reflected can be detected and processed. Such scattered or reflected energy can be referred to as an acoustic echo signal. Generally, such an acoustic inspection scheme involves use of acoustic frequencies in an ultrasonic range of frequencies, such as including pulses having energy in a specified range that can include values from, for example, a few hundred kilohertz, to tens of megahertz, as an illustrative example. Various ultrasonic testing (UT) approaches are capable of detecting different feature or defect orientations.

In various applications, phased array ultrasonic testing or other acoustic inspection techniques can be used to provide non-destructive testing of elongate workpiece structures such as bars (e.g., metallic bars such as steel bars having a circular or square profile). For example, angle-beam ultrasonic inspection is widely used in the steel and metals industry to detect internal flaws in such bars, including cracks, voids, and inclusions, by transmitting ultrasonic pulses into the bar at an oblique angle relative to its surface, causing the pulses to travel through the bar along diagonal acoustic paths, and receiving and analyzing reflected signals to detect anomalies within the material. Such inspection can be performed using a Bar Inspection System (BIS), in which a reservoir (sometimes referred to as a couplant chamber) houses an acoustic coupling medium or “couplant” (e.g., water) and active surfaces of an ultrasonic probe are immersed in the couplant along with a portion of the object under test. The object under test may be translated relative to the ultrasonic probe, such as inserted into or through one or more gates to an immersed region where the ultrasonic probe can be acoustically coupled with the object under test.

### SUMMARY

In one aspect, the present disclosure provides an ultrasonic inspection system for inspecting workpieces having different cross-sectional dimensions. The ultrasonic inspection system includes an ultrasonic probe, a calibration body, and a control circuit. The ultrasonic probe is operable to transmit a plurality of angle-beam ultrasonic pulses toward a workpiece and receive reflected pulse signals. The calibration body includes a plurality of reference reflectors, and the calibration body is positionable relative to the ultrasonic probe such that respective pulses of the plurality of angle-beam ultrasonic pulses intersect corresponding reference reflectors along different acoustic travel paths within the calibration body. The control circuit is operatively coupled to the ultrasonic probe and can receive ultrasonic responses corresponding to reflected pulse signals from the reference reflectors, generate a time-compensated gain (TCG) curve by aggregating amplitude responses of the ultrasonic responses with corresponding acoustic travel depths, normalize the TCG curve based on a cross-sectional dimension of the calibration body to produce a normalized TCG curve, and apply the normalized TCG curve to inspection of a test workpiece having a cross-sectional dimension different from that of the calibration body by rescaling the normalized depth in proportion to the cross-sectional dimension of the test workpiece to determine a gain value applied during inspection.

In one aspect, the present disclosure provides a method of calibrating an angle-beam ultrasonic inspection system for inspecting workpieces having different cross-sectional dimensions. The method includes positioning a calibration body in a beam uniformization position relative to an ultrasonic probe such that reference reflectors within the calibration body are at a substantially uniform distance from an active region of the ultrasonic probe. The method further includes recording, for each of a plurality of angle-beam ultrasonic pulses emitted by the ultrasonic probe, a peak amplitude response from a corresponding reference reflector of the calibration body, and determining gain corrections to substantially equalize the recorded peak amplitude responses across the plurality of angle-beam ultrasonic pulses. The method further includes positioning the calibration body in a Time Compensated Gain (TCG) generation position relative to the ultrasonic probe such that respective pulses of the angle-beam ultrasonic pulses, as gain-corrected, intersect corresponding reference reflectors along different acoustic travel paths within the calibration body, and recording, for each gain-corrected angle-beam ultrasonic pulse, a peak amplitude response from the corresponding reference reflector at an acoustic travel depth corresponding to the acoustic travel path of that pulse within the calibration body. The method further includes generating a TCG curve by aggregating the recorded peak amplitude responses with the corresponding acoustic travel depths, and normalizing the TCG curve relative to a cross-sectional dimension of the calibration body to produce a normalized TCG curve. The normalized TCG curve is applicable to inspection of a test workpiece having a cross-sectional dimension different from the cross-sectional dimension of the calibration body by rescaling the normalized depth in proportion to the cross-sectional dimension of the test workpiece to determine a gain value applied during inspection.

In one aspect, the present disclosure provides a calibration body for use with an angle-beam ultrasonic inspection system. The calibration body includes a plurality of exterior surfaces, a first set of reference reflectors formed within the calibration body at a substantially uniform depth below a first exterior surface of the plurality of exterior surfaces, and a second set of reference reflectors formed within the calibration body at a substantially uniform depth below a second exterior surface of the plurality of exterior surfaces. Each reference reflector of the first set is a hole extending within the calibration body along an axis oriented at an angle relative to a longitudinal axis of the calibration body, and the first set of reference reflectors is located in a first axial zone along the longitudinal axis. Each reference reflector of the second set is a hole extending within the calibration body along an axis oriented at an angle relative to the longitudinal axis, and the second set of reference reflectors is located in a second axial zone along the longitudinal axis distinct from the first axial zone.

### BRIEF DESCRIPTION OF THE DRAWINGS

FIG. 1 is a schematic diagram of an ultrasonic inspection system, according to at least one embodiment of the present disclosure.

FIG. 2 is diagram illustrating angle-beam ultrasonic pulses transmitted at oblique angles traversing different acoustic travel paths within workpieces of different cross-sectional dimensions, according to at least one embodiment of the present disclosure.

FIG. 3 is a perspective view of a calibration body, according to at least one embodiment of the present disclosure.

FIG. 4A is a cross-sectional view of the calibration body of FIG. 3 taken at one of the axial zones, according to at least one embodiment of the present disclosure.

FIG. 4B is a cross-sectional view of the calibration body of FIG. 3 at a different axial zone compared to FIG. 4A, according to at least one embodiment of the present disclosure.

FIG. 4C is top view of a first axial zone of the calibration body of FIG. 3, according to at least one embodiment of the present disclosure.

FIG. 5 is a schematic diagram of a multi-probe embodiment of the ultrasonic inspection system, according to at least one embodiment of the present disclosure.

FIG. 6A is a cross-sectional view of the calibration body positioned in a beam uniformization position relative to an ultrasonic probe, according to at least one embodiment of the present disclosure.

FIG. 6B is a cross-sectional view of the calibration body positioned in a Time Compensated Gain (TCG) generation position relative to the ultrasonic probe, according to at least one embodiment of the present disclosure.

FIG. 6C is a cross-sectional view of the calibration body at the axial location of the sensitivity reference reflector, according to at least one embodiment of the present disclosure.

FIG. 7 is a graphical representation of a TCG curve generated from the peak amplitude responses recorded in a TCG generation position, showing gain in decibels as a function of depth within the calibration body, according to at least one embodiment of the present disclosure.

FIG. 8 is a flowchart illustrating the method of calibrating an angle-beam ultrasonic inspection system, according to at least one embodiment of the present disclosure.

FIG. 9 is a chart showing experimental TCG curves recorded for bars of multiple different cross-sectional dimensions, expressed as gain in decibels as a function of absolute depth in millimeters, according to at least one embodiment of the present disclosure.

FIG. 10 is a chart showing the same TCG data as FIG. 9, but with the depth axis expressed as a percentage of the cross-sectional dimension of each respective bar, according to at least one embodiment of the present disclosure.

FIG. 11 is a block diagram of an example comprising a machine upon which various aspects of the method discussed herein may be performed, according to at least one embodiment of the present disclosure.

### DESCRIPTION

Embodiments of the method and system disclosed herein can support inline inspection of workpieces having different cross-sectional dimensions using as few as a single calibration body to cover a range of different workpiece sizes. In some embodiments, in an immersion-based Bar Inspection System (BIS), an ultrasonic probe may be at a fixed position and may accept varying test workpiece sizes. Differences in the workpiece sizes can change the distance between the ultrasonic probe and the workpiece, and with angle-beam inspection, differences in workpiece sizes also change the acoustic travel paths through which the beam propagates within the workpieces. For example, the same acoustic beam may propagate to a greater depth in a larger bar compared to a smaller bar, and in the absence of the present teachings, a calibration performed on one bar size may not be valid on another bar size because of the changes in the acoustic travel paths. Various aspects of the system and method disclosed can address these challenges by expressing a Time Compensated Gain (TCG) determination as a function of a normalized depth (e.g., depth expressed as a percentage of a cross-sectional dimension of the workpiece). The normalized TCG may be used for applying gain corrections to workpieces of different sizes, enabling a single calibration of the ultrasonic probe using a single calibration body to support inspection of workpieces across a range of cross-sectional dimensions. As used herein, the “size” of a calibration body or a workpiece may generally refer to a cross-sectional dimension of the workpiece or calibration body, such as a width or height of a rectangular bar, by contrast to an axial length in a long dimension.

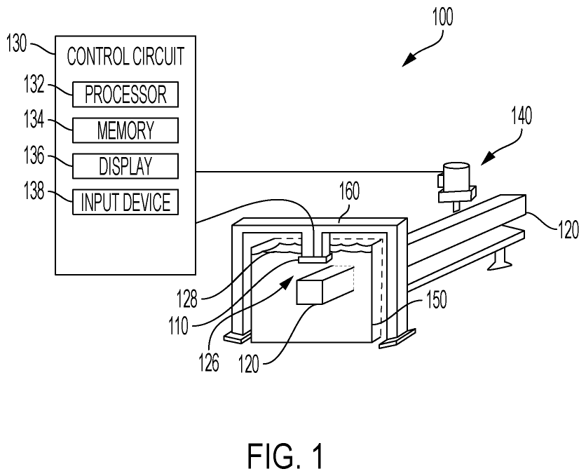

Referring to FIG. 1, an ultrasonic inspection system 100 according to an embodiment of the present disclosure may comprise an ultrasonic probe 110, a workpiece 120, a coupling region 126 providing an acoustic propagation path between the ultrasonic probe and the workpiece, and a control circuit 130 operatively coupled to the ultrasonic probe. The ultrasonic inspection system may be configured as a bar inspection system (BIS) for performing non-destructive inspection of workpieces (e.g., bars) having different cross-sectional sizes, such as carbon steel, stainless steel, aluminum, or titanium bars having polygonal (e.g., square or rectangular) cross-sectional profiles. The ultrasonic probe may be operable to transmit a plurality of angle-beam ultrasonic pulses toward a workpiece and receive reflected pulse signals (echoes) associated with internal features, surface features, reference reflectors, and/or discontinuities within the workpiece. In various embodiments, the plurality of angle-beam ultrasonic pulses may be arranged as an array. In angle-beam ultrasonic inspection, ultrasonic pulses may be transmitted into the workpiece at an oblique angle relative to the surface of the workpiece, causing the pulses to refract and propagate within the workpiece as shear waves (also referred to as transverse waves) along diagonal acoustic paths. The angle-beam shear wave inspection mode may be particularly suited for detecting internal flaws such as cracks, voids, and inclusions oriented at various angles within the workpiece cross-section.

In various embodiments, the ultrasonic probe may be implemented as a phased-array ultrasonic transducer comprising a plurality of individually addressable piezoelectric transducer elements arranged in a linear array. The portion of the ultrasonic probe comprising the transducer elements can define an active region of the ultrasonic probe. The transducer elements may follow a linear contour, although curved contours or two-dimensional matrix arrangements of transducer elements may also be used. Transducer element size and pitch may be varied according to the inspection application. Each transducer element, or group of transducer elements, may be excited with controlled timing delays to transmit a respective angle-beam ultrasonic pulse directed into the bar at a selected oblique angle. The angle of transmission and the focal characteristics of each pulse may be varied by adjusting the timing delays (also referred to as focal laws) applied to individual elements of the array, thereby enabling electronic beam steering and focusing without mechanical movement of the probe.

The coupling region may provide acoustic contact between the ultrasonic probe and the workpiece under inspection through a coupling medium 128. The coupling medium may include a liquid couplant, such as water, providing an immersion or water-path coupling between the ultrasonic probe and the workpiece. In one embodiment, the ultrasonic inspection system may include an immersion tank 150 (also sometimes referred to as a couplant chamber) in which an active region of the ultrasonic probe and a portion of the workpiece under inspection are immersed in the coupling medium. The use of an immersion arrangement may provide consistent and reproducible acoustic contact and may reduce sensitivity to surface condition variations. In other embodiments, the coupling medium may include a fluid or gel, a solid membrane (e.g., an elastomer or other polymer material), or a combination of fluid, gel, or solid structures. Workpieces under test may be positioned at a standoff distance from the ultrasonic probe, and the standoff distance may vary depending on the size of the workpiece.

The ultrasonic inspection system may include mechanical supports, rollers, guides, and/or a translator to maintain a controlled relative pose between the workpiece and the ultrasonic probe during calibration and inspection. In some embodiments, the ultrasonic inspection system may include a probe support structure 160 (also sometimes referred to as a cassette) disposed within and/or around the immersion tank for supporting one or more ultrasonic probes. The probe support structure may maintain the ultrasonic probe at a controlled position and orientation relative to the workpiece under inspection. In some embodiments, the ultrasonic inspection system may include a plurality of ultrasonic probes mounted on the probe support structure, with probes grouped for specific workpiece diameter or size ranges and workpiece shapes. The probe support structure may be equipped with fluid jets (e.g., high-pressure water jets) to remove particles and bubbles from the probe surfaces.

The ultrasonic inspection system may further include a motorized linear drive 140 configured to translate the workpiece along its longitudinal axis relative to the ultrasonic probe. The motorized linear drive may be controlled by the control circuit (e.g., a machine controller in communication with the control circuit). The workpiece under inspection may be translated relative to the ultrasonic probe such that the entire workpiece cross-section is inspected as the workpiece moves through the system. During calibration, the motorized linear drive may position a calibration body (e.g., a calibration bar) at selected axial locations to align reference reflector zones with the ultrasonic probe, as described further herein.

The control circuit may be operatively coupled to the ultrasonic probe and may control the transmission and reception of ultrasonic pulses, process received pulse signals, and/or perform the calibration, normalization, rescaling, and/or inspection functions described herein. The control circuit may include one or more processor 132, one or more memory 134, timing circuitry, and a front-end circuit comprising one or more transmitter signal chains, one or more receiver signal chains, and/or transmit/receive switching circuitry.

The transmitter signal chain may include amplifier and filter circuitry configured to generate transmit pulses for delivery to the ultrasonic probe for insonifying the workpiece under inspection. The receiver signal chain may include one or more filters, amplifier circuits, and an analog-to-digital conversion (ADC) facility configured to digitize echo signals received by the ultrasonic probe. Digitization may be performed coherently, such as to provide multiple channels of digitized data aligned or referenced to each other in time or phase.

The control circuit may include beamforming circuitry configured to apply timing delays to individual transducer elements for beam steering and focusing, and signal processing circuitry for gating, peak detection, and gain application. Gain may be represented in linear amplitude scaling and/or in decibels (dB), and may be applied in transmit, receive, digital signal processing, or combinations thereof.

The one or more processor may be coupled to the one or more memory circuit and may execute machine-readable instructions stored therein to cause the ultrasonic inspection system to perform one or more of acoustic transmission, acoustic acquisition, signal processing, gain application, calibration, beam uniformization, TCG generation, normalization, rescaling, beam selection, reference adjustment, data storage, or any other operations or techniques shown and described herein.

The control circuit may include or be communicatively coupled to a display 136 for presentation of configuration information, calibration results, inspection data, and alarm indications. The control circuit may include or be communicatively coupled to one or more input devices 138, such as including one or more of a keyboard, trackball, function keys, soft keys, mouse interface, touch-screen, stylus, or the like, for receiving operator commands, configuration information, or responses to queries.

In some embodiments, the control circuit may be communicatively coupled to other portions of the ultrasonic inspection system or to external systems using a wired or wireless communication interface. For example, performance of one or more techniques described herein may be accomplished on-board the control circuit or using other processing or storage facilities, such as a remote compute facility, a general-purpose computing device (e.g., a laptop, tablet, desktop computer, or the like), or a combination thereof. Processing tasks that would be undesirably slow if performed on-board the control circuit may be performed remotely, such as in response to a request from the control circuit. Similarly, storage of inspection data, calibration data, A-scan data, or intermediate data may be accomplished using remote storage facilities communicatively coupled to the control circuit. In some embodiments, the control circuit may be integrated within a dedicated ultrasonic test instrument or pulser/receiver unit. In some embodiments, the control circuit may comprise a combination of a dedicated ultrasonic instrument and a separate computing system that performs the normalization, rescaling, and data management operations described herein. The control circuit may interface with a production line control system, a machine controller, or a supervisory system to receive workpiece size information, production parameters, and inspection setup configurations, and to output inspection results, accept/reject determinations, and calibration status information.

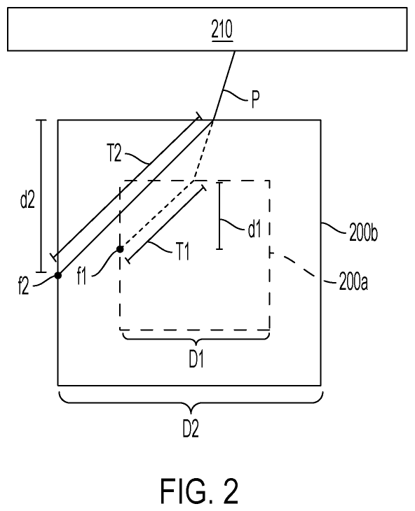

A fundamental challenge of conventional angle-beam ultrasonic inspection arises from the relationship between the cross-sectional dimension of a workpiece under inspection and the acoustic travel paths of the angle-beam ultrasonic pulses within that workpiece, for example, as discussed further with respect to FIG. 2.

FIG. 2 illustrates two workpieces (e.g., bars) having different cross-sectional dimensions: a first workpiece 200a having a first cross-sectional dimension D1 and a second workpiece 200b having a second cross-sectional dimension D2, where D2 is greater than D1. Each of the first workpiece and the second workpiece is positioned relative to an ultrasonic probe 210 operable to transmit a plurality of angle-beam ultrasonic pulses. Because the angle-beam ultrasonic pulses are transmitted at an oblique angle relative to the side surface of the workpiece, the acoustic travel path of each pulse within the workpiece may be a diagonal path from the entry point at the surface to the point at which the pulse intersects a flaw or the opposite surface. The depth at which a given pulse may intersect a feature within the workpiece and consequently the acoustic path length traveled by that pulse may therefore be directly dependent on the cross-sectional dimension of the workpiece.

As shown in FIG. 2, for the first workpiece having cross-sectional dimension D1, a given angle-beam ultrasonic pulse P traveling at an oblique angle may intersect an internal feature f1 at a depth d1 within the workpiece, corresponding to an acoustic travel path of length T1. For the second workpiece having the larger cross-sectional dimension D2, the same pulse P, transmitted at the same angle, may intersect a corresponding internal feature f2 at a greater depth d2 within the workpiece, corresponding to a longer acoustic travel path T2. Because the amplitude of an ultrasonic signal may decrease with the length of the acoustic travel path (e.g., due to beam spreading, geometric divergence, and/or material attenuation) the peak amplitude response recorded from a flaw at depth d2 in the larger workpiece may be substantially lower than that recorded from an equivalent flaw at depth d1 in the smaller workpiece, even if both flaws are identical in size and reflectivity.

This depth and path-length dependency presents a challenge when calibrating for workpieces of different cross-sectional dimensions. A TCG curve generated using a calibration body of cross-sectional dimension D1 matching that of the first workpiece of FIG. 2 may assign gain compensation values at the depths d1 associated with that workpiece size. When that same TCG curve is applied to inspection of the larger workpiece, the gain compensation values may be referenced to the wrong depths, as the curve may compensate for attenuation at depths appropriate for the smaller workpiece rather than the larger one. Inspection of the larger workpiece using the TCG curve from the smaller calibration body may therefore result in either under-compensation or over-compensation of the gain at each inspection depth, potentially leading to inaccurate detection sensitivity and missed or falsely reported flaws.

To address this challenge, some approaches may require generating a new TCG curve for each workpiece cross-sectional dimension to be inspected. This in turn may require a dedicated calibration body for each workpiece size. In a production environment where workpieces of multiple cross-sectional dimensions are inspected, such an approach may require maintaining an inventory of calibration bodies at each size and performing a full recalibration sequence each time the workpiece size changes. This may be operationally burdensome, time-consuming, and may introduce potential sources of variability between calibration runs. There exists a need for an alternate ultrasonic inspection system and method.

Embodiments of the system and method disclosed herein may address these various challenges through a normalization and rescaling approach. For example, rather than determining a TCG for each angle-beam ultrasonic pulse of an ultrasonic probe tied to absolute depths of a specific calibration body size, a control circuit operatively coupled to an ultrasonic probe may generate and normalize a TCG curve relative to the cross-sectional dimension of the calibration body, producing a normalized TCG curve that expresses gain as a function of normalized depth values independent of any particular cross-sectional dimension. Each absolute depth value recorded during calibration may be expressed as a normalized value (e.g., a fraction or percentage of the cross-sectional dimension of the calibration body) yielding a depth scale that is dimensionless and not tied to any specific workpiece geometry. The normalized TCG curve may then be applied to inspection of workpieces of different cross-sectional dimensions by rescaling the normalized depth values in proportion to the corresponding cross-sectional dimensions of the test workpieces, adjusting the depth-gain relationship to reflect the acoustic travel paths within that specific test workpiece. The gain value determined at each rescaled depth may then be applied during inspection at the corresponding inspection depth. In this manner, a single calibration body and a single calibration procedure may support inspection of test workpieces across a broad range of cross-sectional dimensions, reducing the need to maintain an inventory of size-matched calibration bodies and to perform a full recalibration each time the workpiece size changes.

In various embodiments, to generate the TCG curve, a calibration body may be positioned relative to the ultrasonic probe in a TCG generation position in which different angle-beam ultrasonic pulses of a pulse array intersect respective reference reflectors at different depths within the calibration body. The reference reflectors may be formed within the calibration body at a substantially uniform depth below at least one of the exterior surfaces of the calibration body. Because different pulses in the array may be directed at different angles or focal depths, positioning the calibration body in the TCG generation position may cause each pulse to intersect its respective reference reflector at a unique depth, with each beam contributing a respective (depth, amplitude) pair. As each beam has a different travel path within the calibration body, each beam may provide only a limited portion of the depth-dependent amplitude information. The control circuit may receive ultrasonic responses corresponding to reflections from the reference reflectors and generate a time-compensated gain (TCG) curve by aggregating amplitude responses of the ultrasonic responses with corresponding acoustic travel depths. By stitching all these partial information portions together (e.g., forming a composite amplitude value versus depth dataset using peak amplitudes and corresponding depths seen by each beam), the control circuit may construct the TCG curve spanning the full inspection depth range of interest. This use of the angle-beam geometry itself to sample multiple depths in a single positioning operation may simplify the TCG generation procedure and may reduce the number of calibration steps required compared to techniques that require sequential repositioning of the calibration body to record responses at each depth individually.

In some embodiments, prior to generating the TCG curve, the calibration body may be arranged in a beam uniformization position in which different angle-beam ultrasonic pulses of the array intersect respective reference reflectors at substantially uniform depths within the calibration body. In this position, any variation in the peak amplitude responses recorded across the pulses may be attributed to beam-to-beam non-uniformity of the probe (e.g., differences in element sensitivity, beam directivity, and acoustic coupling efficiency) rather than to depth-dependent attenuation. The control circuit may determine gain corrections to substantially equalize the amplitude responses across the array of angle-beam ultrasonic pulses based on the responses recorded in the beam uniformization position, and may apply these gain corrections to each pulse individually before proceeding to TCG generation. In this manner, by removing the inherent amplitude non-uniformities of the probe before constructing the TCG curve, the system may ensure that the resulting TCG curve accurately reflects the depth-dependent attenuation characteristics of the material being inspected, rather than a combination of material attenuation and probe non-uniformity. This may improve the accuracy and reliability of flaw detection across the full depth range of a workpiece, and may reduce the sensitivity of the inspection results to probe-to-probe manufacturing variations.

In certain embodiments, the ultrasonic inspection system may comprise a plurality of ultrasonic probes, with a calibration body being positionable such that each of its four exterior surfaces respectively faces one of the plurality of ultrasonic probes. The control circuit may independently perform beam uniformization and generate and normalize a TCG curve to calibrate each probe. This multi-probe configuration may enable simultaneous or sequential inspection of all four faces of a workpiece in a single pass, which may substantially increase inspection throughput. Independent calibration of each probe may further ensure that beam-to-beam non-uniformities and depth-gain characteristics are accurately characterized for each probe channel individually, rather than applying a single shared calibration to all probes.

In some embodiments, to streamline calibration of a multi-probe ultrasonic inspection system, the reference reflectors within the calibration body may be organized into a plurality of sets. For example, the reference reflectors may be arranged in at least a first set, a second set, a third set, and a fourth set, with each set corresponding to a respective one of the four exterior surfaces of the calibration body. Each set may be located at a respective distinct axial zone along the longitudinal axis of the calibration body. This organization may allow each probe to interact with a corresponding set (or corresponding sets) of reference reflectors during calibration without the need to remove or rotate the calibration body between activations of different probes.

In some embodiments, a motorized linear drive may translate the calibration body along the longitudinal axis relative to the plurality of ultrasonic probes, selectively aligning each axial zone with its respective probe to position the reference reflectors of each set in a beam uniformization position and a TCG generation position relative to that probe. The motorized linear drive may automate the entire calibration sequence (e.g., beam uniformization followed by TCG generation for each probe in turn) by sequential axial translation.

In some embodiments, the reference reflectors may be holes formed within the interior of the calibration body, each hole extending within the calibration body along an axis oriented at an angle relative to the longitudinal axis of the calibration body. As the calibration body is moved axially relative to the ultrasonic probe during TCG generation, the angular orientation of each hole may cause the effective lateral position of that hole, as intercepted by the respective angle-beam ultrasonic pulse, to shift progressively along the axis of the hole. This progressive lateral shift may enable each pulse to scan across its respective reference reflector during axial movement and achieve optimal alignment near the center of the reference reflector (e.g., thereby recording a true peak amplitude response rather than an off-center partial response).

In some embodiments, the calibration body may further comprise one or more sensitivity reference reflector, which may be a surface notch formed in one or more of the four exterior surfaces of the calibration body. Each sensitivity reference reflector may be formed at a location axially separate from the sets of reference reflectors used for beam uniformization and TCG generation. The control circuit may use the sensitivity reference reflector to perform a global reference adjustment operation. For example, a peak amplitude response for the sensitivity reference reflector may be recorded by one or more of the angle-beam ultrasonic pulses, a global gain offset may be determined to bring that response to a predetermined reference amplitude. The global gain offset may be applied uniformly to all angle-beam ultrasonic pulses. The global gain offset adjustment is distinct from beam uniformization. Beam uniformization can correct for relative differences in sensitivity between individual pulses within the array whereas the global reference adjustment can set the absolute sensitivity level of the entire inspection system according to a determined baseline.

In some embodiments, the control circuit may further adjust a number of angle-beam ultrasonic pulses actively transmitted by the ultrasonic probe based on the cross-sectional dimension of the workpiece under inspection or of the calibration body being used for calibration. When the cross-sectional dimension of a workpiece or calibration body is smaller than the full active region of the probe, pulses at the edges of the array may follow acoustic paths that do not intercept the workpiece or calibration body at any relevant inspection depth. The control circuit may deactivate such pulses, restricting the active region to only those pulses whose paths are geometrically positioned to intercept the test workpiece or calibration body.

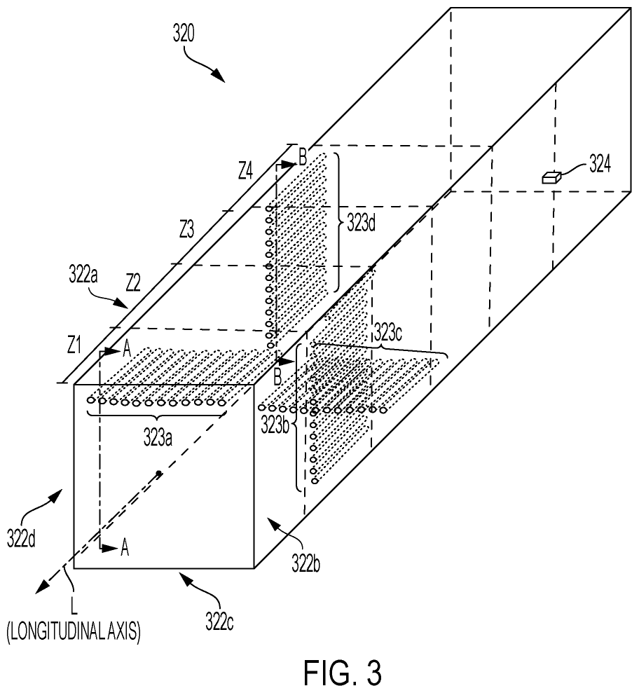

FIG. 3 depicts a calibration body 320 according to various embodiments of the present disclosure.. The calibration body may have four exterior surfaces 322a, 322b, 322c, 322d and a longitudinal axis L extending along the length of the calibration body. In one embodiment, the calibration body may be a bar (e.g., an elongated body having a substantially uniform cross-section along its length), although other structural forms may be used.

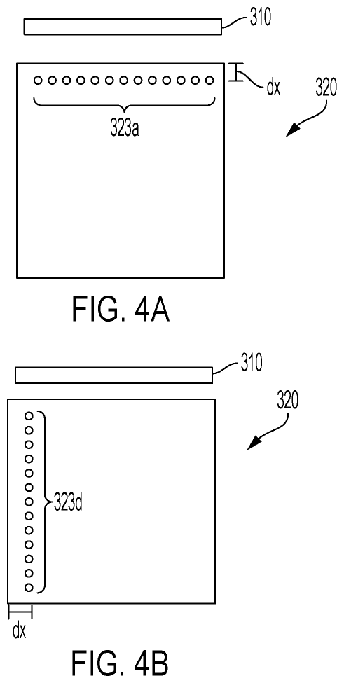

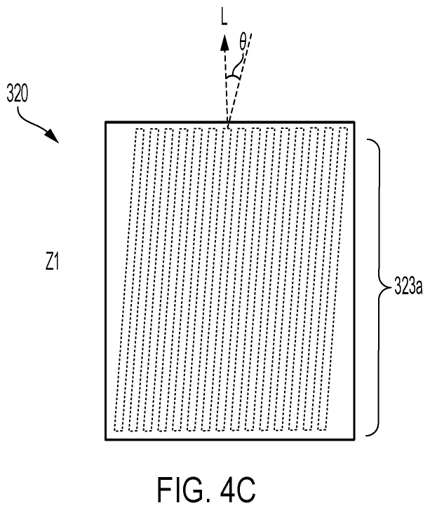

Reference reflectors 323 may be formed within the calibration body at a substantially uniform depth dx below at least one of the exterior surfaces. In various embodiments, the reference reflectors may be formed at a depth in a range of approximately 5 to 10 millimeters below the respective exterior surface. In various embodiments, each reference reflector may be a hole formed within an interior of the calibration body, such as a side-drilled hole, extending within the calibration body along an axis oriented at an angle relative to the longitudinal axis L of the calibration body, as discussed further with respect to FIG. 4C.

Referring to FIG. 3, the reference reflectors may be organized into a plurality of sets. In some embodiments, the reference reflectors may be organized into at least a first set 323a and a second set 323b. In some embodiments (e.g., for use with a multi-probe embodiment system), the reference reflectors may be further organized into a third set 323c and/or a fourth set 323d. Each set of reference reflectors may correspond to a respective one of the four exterior surfaces of the calibration body and may be formed at a substantially uniform depth below that exterior surface.

Each set of reference reflectors may be located at a respective distinct axial zone along the longitudinal axis L. For example, in a four-set embodiment as illustrated by FIG. 3, the first set may be located at a first axial zone Z1, the second set at a second axial zone Z2, the third set at a third axial zone Z3, and the fourth set at a fourth axial zone Z4, with each of the four axial zones being distinct from one another along the longitudinal axis.

FIG. 4A is a cross-sectional view of the calibration body taken along section A-A of FIG. 3 at a first axial zone, illustrating the calibration body positioned in the beam uniformization position relative to an ultrasonic probe 310, in which the reference reflectors of the corresponding set are at a substantially uniform distance from the ultrasonic probe, such that different angle-beam ultrasonic pulses can intersect respective reference reflectors at substantially uniform depths within the calibration body.

FIG. 4B is a cross-sectional view of the calibration body taken along section B-B of FIG. 3, at a different axial zone than FIG. 4A. FIG. 4B illustrates the calibration body positioned in the TCG generation position relative to the ultrasonic probe, in which different angle-beam ultrasonic pulses of the plurality intersect respective reference reflectors along different acoustic travel paths (e.g., at different depths) within the calibration body. Together, FIGS. 4A and 4B illustrate how the calibration body may be translated along the longitudinal axis L to transition from the beam uniformization position to the TCG generation position, with a first set of reference reflectors at a first axial zone (e.g., Z1) serving the beam uniformization position (FIG. 4A) and a different set of reference reflectors (e.g., the fourth set of reference reflectors) at a different axial zone (e.g., the fourth axial zone Z4) serving the TCG generation position (FIG. 4B). This way, simply by moving the calibration body forward and backwards in the axial direction, probes on all four faces can be calibrated and the 90-degree offset is available without having to remove the calibration body and physically rotate it for another pass.

FIG. 4C is top view of the calibration body limited to showing the first axial zone Z1 depicted in FIG. 3. As shown in FIG. 4C, the reference reflectors may be holes formed within the interior of the calibration body, each hole extending along an axis oriented at an angle θ relative to the longitudinal axis L of the calibration body. Thus, as the calibration body is moved axially relative to the ultrasonic probe, the angular orientation of each hole may cause the effective lateral position of that hole, as intercepted by the respective angle-beam ultrasonic pulse, to shift progressively along the axis of the hole. This progressive lateral shift may enable each pulse to scan across its respective reference reflector during axial movement and achieve optimal alignment near the center of the reference reflector.

In various embodiments, each set of reference reflectors may be substantially identical to the others (e.g., comprising the same number of reference reflectors, each reference reflector having substantially the same dimensions, each reference reflector oriented at substantially the same angle relative to the longitudinal axis, each reference reflector at substantially the same depth relative to its corresponding side) with the sets differing in their respective positions along the longitudinal axis and their respective exterior surfaces. This uniformity of configuration may ensure that the calibration body produces consistent and reproducible reference responses on all four sides.

The calibration body may further comprise one or more sensitivity reference reflectors 324. Each sensitivity reference reflector may be formed at a respective axial location along the longitudinal axis that is distinct from the axial zones of the reference reflector sets. In one embodiment, a respective sensitivity reference reflector may be formed in each of the four exterior surfaces of the calibration body, such that each of the plurality of ultrasonic probes may have a corresponding sensitivity reference reflector for performing a reference adjustment operation. Each sensitivity reference reflector may be a surface notch formed in the respective exterior surface of the calibration body. The one or more sensitivity reference reflectors may be used to perform a reference adjustment operation, as described further herein.

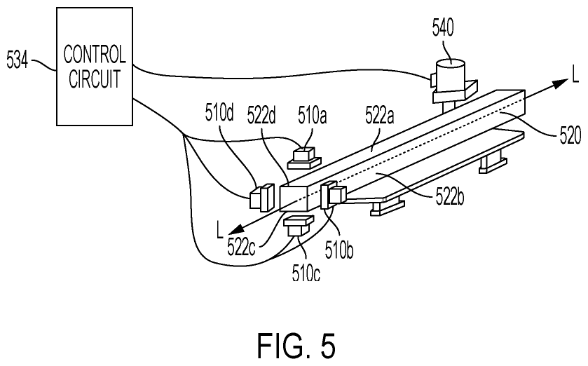

Referring to FIG. 5, in certain embodiments, an ultrasonic inspection system 500 may comprise a plurality of ultrasonic probes 510a, 510b, 510c, 510d arranged such that each of the four exterior surfaces 522a, 522b, 522c, 522d of a calibration body 520 faces a respective one of the plurality of ultrasonic probes. The ultrasonic inspection system 500 may be similar to the ultrasonic inspection system 100 described with respect to FIG. 1 and may include any of the aspects disclosed relative to FIG. 1. The calibration body may be similar to the calibration body described with respect to FIG. 3 and may include any of the aspects disclosed relative to FIGS. 3, 4A, and 4B. A control circuit 530 may be operatively coupled to each of the plurality of ultrasonic probes and may independently perform beam uniformization and generate and normalize a TCG curve for each probe.

As further shown in FIG. 5, the ultrasonic inspection system may comprise a motorized linear drive 540 configured to translate the calibration body along the longitudinal axis L relative to the plurality of ultrasonic probes. The motorized linear drive may selectively align each axial zone of the calibration body with the plurality of ultrasonic probes such that each set of reference reflectors may be positioned in the beam uniformization position relative to a first one of the plurality of ultrasonic probes and in the TCG generation position relative to a second, different one of the plurality of ultrasonic probes. In this manner, each ultrasonic probe may have a corresponding set of reference reflectors for performing beam uniformization and a different corresponding set of reference reflectors for performing TCG generation. The motorized linear drive may thereby enable the complete calibration sequence to be performed for each probe by sequential axial translation of the calibration body.

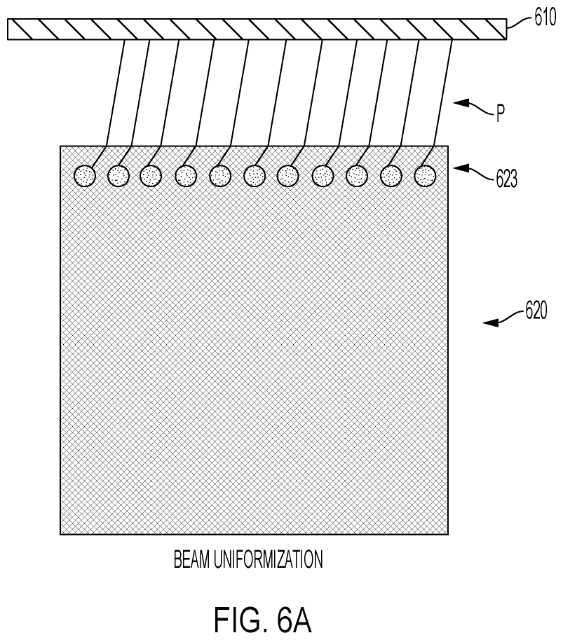

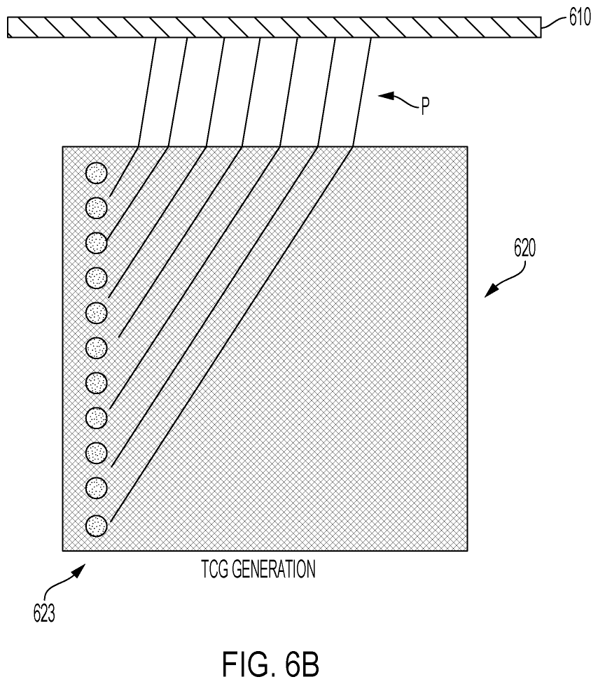

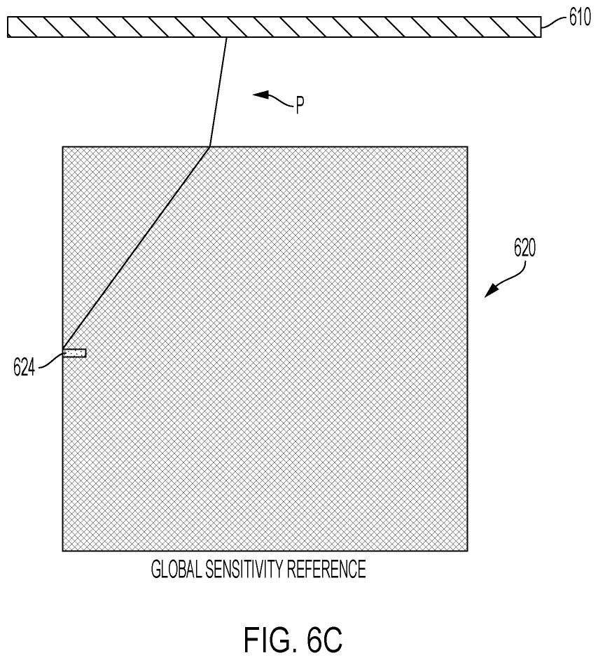

FIGS. 6A, 6B, and 6C illustrate an example calibration process performable by an ultrasonic inspection system according to various embodiments of the present disclosure. The ultrasonic inspection system, including a control circuit and an ultrasonic probe 610, may be similar to the ultrasonic inspection system described with respect to FIG. 1 and/or the ultrasonic inspection system described with respect to FIG. 5, and may include any of the aspects disclosed relative to FIGS. 1 and 5. A calibration body 620 may be similar to the calibration body described with respect to FIG. 3 and may include any of the aspects disclosed relative to FIGS. 3, 4A, and 4B.

FIG. 6A corresponds to a beam uniformization operation in which the calibration body is positioned relative to the ultrasonic probe such that amplitude responses may be recorded and gain corrections may be determined to substantially equalize the responses across an array of angle-beam ultrasonic pulses transmitted by the ultrasonic probe. FIG. 6B corresponds to a TCG generation operation in which the calibration body is repositioned relative to the ultrasonic probe such that peak amplitude responses may be recorded at varying depths to construct a TCG curve. FIG. 6C corresponds to a global reference adjustment operation in which a sensitivity reference reflector of the calibration body is used to establish an absolute sensitivity baseline for the inspection system. Each of these operations is described in further detail below.

Referring to FIG. 6A, the calibration body may be positioned relative to the ultrasonic probe in a beam uniformization position. In the beam uniformization position, reference reflectors 623 within the calibration body may be at a substantially uniform distance from the active region of the ultrasonic probe 610. This geometry may ensure that different angle-beam ultrasonic pulses P of the array, each directed toward a respective reference reflector, travel substantially the same acoustic path length from the active region to their respective reference reflector. As a result, the peak amplitude response recorded by each pulse may reflect primarily the individual characteristics of that pulse (e.g., element sensitivity, beam directivity, and coupling efficiency) rather than depth-dependent attenuation effects. In the beam uniformization position, the control circuit may: select an active set of beams to be used for the workpiece size under calibration; transmit each beam and receive corresponding echo signals; apply time gates around expected echo times for the reference reflectors; determine, for each beam, a peak amplitude response associated with the corresponding reference reflector, where the peak amplitude may be a maximum within a gate or a fitted peak value; and compute per-beam gain corrections to equalize the set of peak amplitudes to a target reference amplitude.

In the beam uniformization position, the control circuit may record, for each angle-beam ultrasonic pulse, a peak amplitude response from its respective reference reflector. Because the reference reflectors may be at a substantially uniform distance from the active region, any variation in the recorded peak amplitude responses across the pulses may be attributable to beam-to-beam non-uniformity rather than depth-dependent attenuation.

The control circuit may then determine gain corrections to substantially equalize the amplitude responses across all angle-beam ultrasonic pulses. In one embodiment, the gain correction for each pulse may be determined by computing the ratio of a target reference amplitude to the peak amplitude response recorded by that pulse in the beam uniformization position, and applying that ratio as a per-pulse gain multiplier. The per-beam gain corrections may be represented as additive dB offsets or multiplicative linear scale factors. The target reference amplitude may be a predetermined amplitude such as a screen height percentage, a digital value, or an amplitude derived from an average or median of the observed responses. The computed per-beam corrections may be stored in memory as a uniformization table indexed by beam number. After the gain corrections are applied, all pulses of the array may be referred to as gain-corrected pulses, leaving depth-dependent attenuation as the dominant factor affecting the amplitude of responses recorded in subsequent TCG generation.

The beam uniformization operation may be performed prior to TCG generation, ensuring that the TCG curve reflects the depth-dependent attenuation characteristics of the material and not the inherent non-uniformities of the probe.

Referring to FIG. 6B, after beam uniformization, the calibration body may be repositioned relative to the ultrasonic probe to the TCG generation position. In the TCG generation position, different angle-beam ultrasonic pulses P of the array may intersect respective reference reflectors at different depths within the calibration body. This arrangement may allow each pulse to record a peak amplitude response from a reference reflector at a unique depth, providing data points across a range of depths from which the TCG curve may be constructed. In the TCG generation position, the control circuit may: apply the per-beam uniformization corrections to the transmit gain, receive gain, and/or post-processing gain associated with each beam; transmit each beam of the selected active set and acquire echo data; determine a peak amplitude response for each beam associated with a respective reference reflector; determine, for each peak amplitude response, an associated depth coordinate or time-of-flight coordinate corresponding to the acoustic travel path to the reference reflector; and aggregate the set of (depth, amplitude) observations across beams to generate a TCG curve.

The depth associated with each pulse's reference reflector may correspond to the acoustic travel path of that pulse within the calibration body. The depth coordinate may be computed from time-of-flight using a propagation velocity for the relevant wave mode in the calibration body material, and may account for water path delay and/or refraction geometry. In some embodiments, the control circuit may compute a sound path distance along the refracted beam and map it to an equivalent depth below the entry surface. In some embodiments, the time coordinate used for TCG application is a time gate index, a sample index, or a microsecond value, and the TCG is applied as a function of time rather than as a function of geometric depth. Different pulses in the array may intersect their respective reference reflectors at different depths within the calibration body, producing a set of amplitude-depth data pairs that span the inspection depth range of interest.

The control circuit may record, for each gain-corrected pulse, a peak amplitude response from its respective reference reflector at the corresponding depth. To record a peak amplitude response accurately, the calibration body may be moved axially relative to the ultrasonic probe (or the probe may be moved relative to the calibration body) such that each pulse may achieve optimal alignment with the center of its respective reference reflector. Because the reference reflectors may be oriented at an angle relative to the longitudinal axis, axial movement between the calibration body and the probe may cause the effective lateral position of each reference reflector, as intercepted by the respective pulse, to shift progressively, enabling each pulse to scan across its respective reference reflector and record the peak of the amplitude response.

The control circuit may then generate a TCG curve by aggregating the recorded peak amplitude responses at their respective depths. In this manner, the TCG curve may not be used in the conventional sense as a way to compensate for amplitude attenuation along the acoustic path, but rather as a way to compensate the amplitude at the destination of the beam at the reference reflector location. The resulting TCG curve may accordingly be valid for detecting flaws proximate to the exterior side surface and may express, for each depth within the calibration body, the gain required to bring the peak amplitude response of a reference reflector at that depth to a reference level.

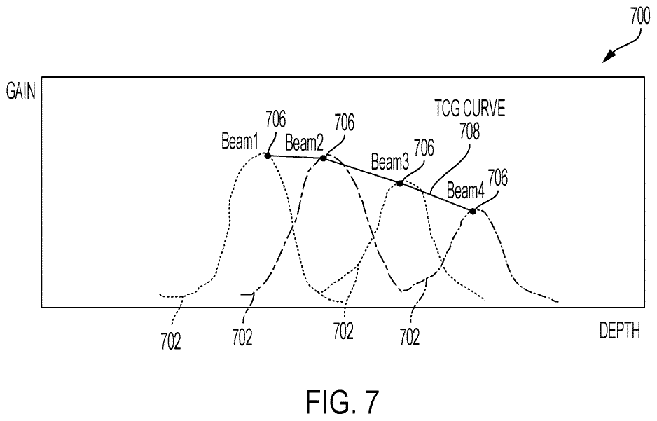

FIG. 7 illustrates an example graph 700 in which a plurality of amplitude curves 702 are plotted as a function of depth. Each amplitude curve may correspond to an A-scan amplitude profile acquired at a respective lateral position and plotted versus depth. Peak amplitudes 706 may be identified for each amplitude curve 702. In various embodiments, as discussed further with respect to FIG. 6C, a gain value associated with each peak amplitude may be computed using a reference adjustment operation. For example, the gain value associated with each peak amplitude may be determined based on a ratio of the measured peak amplitude to a reference amplitude, such as by computing gain in decibels as G=20·log10(A/Aref), where A is the measured peak amplitude and Aref is a predetermined reference amplitude (e.g., a calibration reference level such as 80% full-screen height).

A TCG curve 708 may be constructed from the set of peak amplitude data points 706. In some embodiments, the TCG curve may be generated using a piecewise linear interpolation approach. For example, each peak amplitude data point may define a respective (depth, gain) pair, denoted TCG_i={depth_i, gain_i}, and the TCG curve 708 may comprise linear interpolation segments between adjacent data points 706 such that, for any depth between depth_i and depth_{i+1}, the gain is determined by linear interpolation between gain_i and gain_{i+1}. The set of (depth, gain) data points may be provided to the control circuit manually by an operator or determined automatically by an automated calibration sequence.

In some embodiments, the piecewise linear interpolation is performed at a hardware level within an acquisition device, such that the control circuit applies the linearly interpolated gain values directly during signal acquisition based on the set of TCG data points.

In some embodiments, the TCG data points are specified in distance units (e.g., millimeters) and converted to time units (e.g., nanoseconds) when passed to the acquisition device for application at the hardware level, using a conversion based on the sound velocity in the material. For example, distance may be converted to time as time=2·depth/velocity, where the factor of two accounts for the round-trip acoustic travel path in a pulse-echo mode of operation.

In other embodiments, the TCG curve may be constructed using curve fitting techniques applied to the set of peak amplitude data points, including, for example, interpolation, regression, piecewise-linear fitting, or spline fitting. In some such embodiments, the TCG curve may take the form of a polynomial function of depth, such as G(d)=a0+a1·d+a2·d²+ . . . +an·dⁿ, where G is the gain in decibels, d is the depth, and a0, a1, . . . an are coefficients determined by the fitting procedure. In some such such embodiments, the TCG curve may take the form of an exponential function, such as G(d)=a·e\hat{ }(b·d)+c, where a, b, and c are fitting parameters. In some embodiments, the TCG curve may be represented as a spline (e.g., a cubic spline) passing through or approximating the set of peak amplitude data points. Because each angle-beam ultrasonic pulse may contribute a single peak amplitude response at a respective depth, the TCG curve may be constructed empirically from the aggregated set of (depth, amplitude) data points contributed by the plurality of pulses, and the particular form of the TCG curve (e.g., piecewise linear interpolation or a fitted curve) may be selected based on the number of data points, the desired smoothness, and the accuracy requirements of the inspection application.

The TCG curve may be used to generate the aggregated TCG curve for application to subsequently acquired or previously acquired data. The aggregated TCG curve may be generated by interpolation between sample points, curve fitting, or piecewise-linear mapping, and may be stored as a set of breakpoints mapping time (or depth) to gain value.

In certain embodiments, transitioning the calibration body from the beam uniformization position to the TCG generation position may be achieved by translating the calibration body along its longitudinal axis. This embodiment may be particularly applicable in a multi-set configuration where a first set of reference reflectors may be used in the beam uniformization position and a second set may be used in the TCG generation position at a different axial zone.

In certain other embodiments, (e.g., for a calibration body with only one set of reference reflectors), the calibration body may be repositioned from the beam uniformization position to the TCG generation position by rotating the calibration body about its longitudinal axis. By rotating the calibration body, the angular orientation of the reference reflectors relative to the probe may change, transitioning the reference reflector geometry from the uniform-depth arrangement of the beam uniformization position to the varying-depth arrangement of the TCG generation position. This may allow the same set of reference reflectors to serve both the beam uniformization and TCG generation operations simply by rotating the calibration body about its longitudinal axis without requiring axial translation.

Referring to FIG. 6C, the calibration body may further comprise one or more sensitivity reference reflector 624. Each sensitivity reference reflector may be formed in the calibration body at a respective axial location that is separate from the axial zones of the reference reflector sets. In one embodiment, a sensitivity reference reflector may be a surface notch formed in one of the four exterior surfaces of the calibration body. In one example, the sensitivity reference reflector may be a surface notch having a depth of approximately 0.5 millimeters and a width of approximately 1 millimeter. The sensitivity reference reflector may provide a known, consistent reflector from which a global sensitivity reference may be established for the inspection system.

The control circuit may perform a reference adjustment operation. In the reference adjustment operation, the control circuit may: position the calibration body such that the sensitivity reference reflector is within an inspection region of the ultrasonic probe; transmit one or more selected beams (which may include one beam, a subset of beams, or the full active set); measure a peak amplitude response from the sensitivity reference reflector; and compute a global gain offset that shifts the overall response level to a predetermined reference amplitude. The predetermined reference amplitude may be a target screen height (e.g., 80% full-screen height) or a target digital amplitude. The global gain offset may be applied uniformly across beams, and may be applied in addition to the per-beam uniformization corrections and the depth-dependent TCG. The reference adjustment operation may ensure that the overall sensitivity of the inspection system is set to a known level before inspection begins, providing a consistent amplitude baseline across all inspections regardless of day-to-day variations in system sensitivity.

The reference adjustment operation may be performed using the gain-corrected pulses (e.g., pulses that have already been corrected for beam-to-beam non-uniformity through the beam uniformization operation). In some embodiments, the global gain offset is applied after per-beam uniformization such that relative per-beam differences remain compensated while the overall sensitivity is set. In some embodiments, the global gain offset is applied prior to per-beam uniformization, and the per-beam corrections are computed in that gain context. The global gain offset may be applied uniformly to all gain-corrected pulses, adjusting the overall system sensitivity without disturbing the relative beam-to-beam corrections already applied.

After the TCG curve has been generated from the peak amplitude responses recorded in the TCG generation position, the control circuit may normalize the TCG curve based on the cross-sectional dimension of the calibration body to produce a normalized TCG curve.

Normalization may be performed by expressing each depth value in the TCG curve as a normalized depth value relative to the cross-sectional dimension of the calibration body. In one embodiment, the normalized depth may be expressed as a dimensionless ratio, as shown below:

nd=d/Dcal

In the above formula, d is an absolute depth coordinate (or an equivalent depth derived from time-of-flight), Dcal is a characteristic cross-sectional dimension of the calibration body, and nd is the resulting normalized depth. For calibration bodies having square or rectangular cross-sections, Dcal may be a crossside length, a diagonal, an equivalent diameter, a circumscribed diameter, an inscribed diameter, or another selected cross-sectional dimension stored as a calibration parameter. In some embodiments, normalized depth is represented as a percentage, as shown below:

nd(%)=100×D/Dcal.

The resulting normalized TCG curve may express gain as a function of normalized depth values, and may therefore not be tied to any particular workpiece size. Where the TCG curve is expressed as G(d), representing gain as a function of absolute depth d, the normalized TCG curve G_norm may be obtained by converting each absolute depth value d to a normalized depth nd=d/Dcal. Because normalization transforms the depth axis and preserves the gain values, the relationship between the TCG curve and the normalized TCG curve may be expressed as:

G_norm(d/Dcal)=G(d)

where Dcal is the cross-sectional dimension of the calibration body. That is, for any absolute depth d in the calibration body, the gain value G(d) from the TCG curve is assigned to the corresponding normalized depth nd=d/Dcal in the normalized TCG curve, such that G_norm(nd)=G(d). The control circuit may store a normalized TCG representation as gain versus normalized depth, with gain values corresponding to the gain values derived for the calibration body, and with the normalized depth values computed from the calibration body size. The normalized TCG may be stored as a normalized breakpoint table, with gain values stored in dB or linear units. In certain implementations, the normalized depth coordinate is derived from a time coordinate by computing an equivalent depth using a velocity model. In other implementations, a normalized time coordinate may be used instead of normalized depth, with normalization performed relative to an expected time-of-flight to a reference boundary determined by workpiece size.

To apply the normalized TCG curve to inspection of a test workpiece having a cross-sectional dimension different from the calibration body, the control circuit may rescale the normalized depth values in proportion to the cross-sectional dimension of the test workpiece. The control circuit may receive the test workpiece size via operator input, a production database, a measurement sensor, or a machine control interface. The test workpiece size may be represented as a characteristic dimension Dtest defined consistently with Dcal. For each normalized breakpoint at normalized depth, nd, the control circuit may compute a rescaled absolute depth, as shown below:

d_test=nd×Dtest

The control circuit may map that d_test to a time-of-flight coordinate (or apply in the depth domain where depth is computed during inspection). The control circuit may then apply the gain values of the normalized TCG at the rescaled depth coordinates during inspection of the test workpiece. In some embodiments, the control circuit performs rescaling by generating a new TCG table indexed by time sample for the test workpiece, where the time locations corresponding to the rescaled depths are computed and the gain values are assigned via interpolation. In some embodiments, the control circuit retains the normalized representation and computes, for each inspection sample at depth d within the test workpiece, the gain by evaluating the normalized TCG curve at a normalized coordinate corresponding to the test workpiece dimension, as shown below:

G_test(d)=G_norm(d/Dtest),

where G_test(d) is the gain applied at absolute depth d within the test workpiece, and G_norm is the normalized TCG curve derived from the calibration body. Equivalently, the control circuit may compute a normalized depth coordinate nd=d/Dtest and determine the gain at that nd from the

### Normalized Table.

This normalization and rescaling approach may allow a single calibration body to support TCG calibration for workpieces across a range of cross-sectional dimensions. Rather than requiring a separate calibration procedure and a separate calibration body for each workpiece size, the operator may perform a single calibration using the calibration body, generate the normalized TCG curve, and then input the cross-sectional dimension of the test workpiece to be inspected. The control circuit may automatically rescale the normalized TCG curve to produce the appropriate gain compensation for the test workpiece.

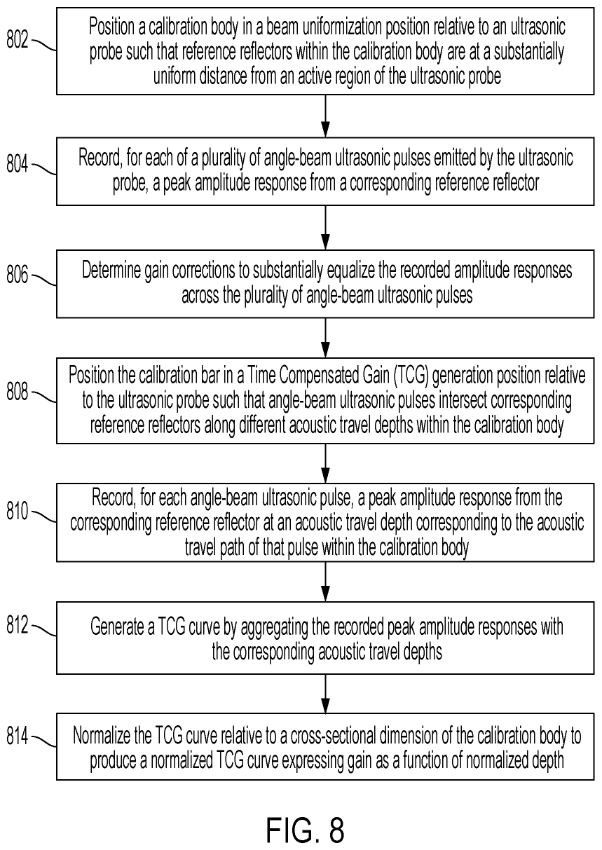

FIG. 8 depicts an embodiment of a method 800 for calibrating an angle-beam ultrasonic inspection system comprising an ultrasonic probe for inspecting workpieces having different cross-sectional dimensions. The method may be implemented using any embodiment of the ultrasonic inspection system disclosed herein. For example, the ultrasonic inspection system may comprise an ultrasonic probe, a calibration body (e.g., a calibration bar), and a control circuit, as described above.

According to the method, the calibration body may be positioned 802 in a beam uniformization position relative to the ultrasonic probe such that reference reflectors within the calibration body are at a substantially uniform distance from an active region of the ultrasonic probe. As described above, this positioning may ensure that different angle-beam ultrasonic pulses of the plurality each travel substantially the same acoustic path length to their respective reference reflectors, so that any variation in the amplitude responses recorded across the pulses is attributable to beam-to-beam non-uniformity of the probe rather than to depth-dependent attenuation of the material.

For each of a plurality of angle-beam ultrasonic pulses emitted by the ultrasonic probe, a peak amplitude response may be recorded 804 from a corresponding reference reflector of the calibration body. Each pulse may scan axially across its respective reference reflector, enabled by the angular orientation of the reference reflectors relative to the longitudinal axis of the calibration body, to achieve optimal alignment with the center of the reference reflector and record a true peak amplitude response.

Gain corrections may be determined 806 to substantially equalize the recorded amplitude responses across the plurality of angle-beam ultrasonic pulses. The gain correction for each pulse may be determined based on the ratio of a target reference amplitude to the peak amplitude response recorded for that pulse and may be applied as a per-pulse gain multiplier. Following this operation, all pulses of the plurality may be treated as gain-corrected pulses whose relative amplitude non-uniformities have been substantially removed.

The calibration body may be positioned 808 in a Time Compensated Gain (TCG) generation position relative to the ultrasonic probe such that respective ones of the angle-beam ultrasonic pulses, as gain-corrected, intersect corresponding reference reflectors along different acoustic travel paths within the calibration body. This repositioning may be accomplished by translating the calibration body along its longitudinal axis to bring a different axial zone of reference reflectors into alignment with the probe, or alternatively by rotating the calibration body about its longitudinal axis to change the angular relationship between the reference reflector geometry and the probe, as described above.

For each gain-corrected angle-beam ultrasonic pulse, a peak amplitude response may be recorded 810 from the corresponding reference reflector at an acoustic travel depth corresponding to the acoustic travel path of that pulse within the calibration body. Each gain-corrected pulse may scan axially across its respective reference reflector to record a true peak amplitude response. The acoustic travel depth associated with each recorded response may correspond to the total acoustic travel path length from the active region of the probe to the corresponding reference reflector in the TCG generation position.

A TCG curve may be generated 812 by aggregating the recorded peak amplitude responses with the corresponding acoustic travel depths. The resulting TCG curve may express, for each acoustic travel depth within the calibration body at which a peak amplitude response was recorded, the gain required to bring that response to a predetermined reference level.

The TCG curve may be normalized 814 relative to the cross-sectional dimension of the calibration body to produce a normalized TCG curve expressing gain as a function of normalized depth. Each absolute depth value in the TCG curve may be expressed as a normalized value (for example, as a fraction or percentage of the cross-sectional dimension of the calibration body) yielding a depth scale that is dimensionless and independent of the absolute size of the calibration body. The normalized TCG curve may then be applied to inspection of a test workpiece having a cross-sectional dimension different from the calibration body by rescaling the normalized depth in proportion to the cross-sectional dimension of the test workpiece, as described above, to determine a gain value applied during inspection.

In certain embodiments, the method may further comprise the use of a calibration body having at least a first set of reference reflectors located at a first axial zone along the longitudinal axis and a second set of reference reflectors located at a second axial zone along the longitudinal axis distinct from the first axial zone. In this embodiment, the method may further comprise translating the calibration body along the longitudinal axis to move the calibration body from the beam uniformization position to the TCG generation position, wherein the first set of reference reflectors is used in the beam uniformization position and the second set of reference reflectors is used in the TCG generation position. This axial separation of the reference reflector sets may ensure that the uniform-depth geometry required for beam uniformization and the varying-depth geometry required for TCG generation are each provided by a dedicated set of reference reflectors optimized for that purpose, without requiring a single set of reference reflectors to satisfy both geometric requirements simultaneously.

In certain embodiments in which the system comprises a plurality of ultrasonic probes, the method may further comprise positioning the calibration body such that the second set of reference reflectors is in the beam uniformization position relative to a second ultrasonic probe. For each of a plurality of angle-beam ultrasonic pulses emitted by the second ultrasonic probe, a peak amplitude response may be recorded from a corresponding reference reflector of the second set of reference reflectors, and gain corrections may be determined to substantially equalize the recorded amplitude responses across the plurality of angle-beam ultrasonic pulses of the second ultrasonic probe, the second set of reference reflectors thereby serving both to generate the TCG curve for the first ultrasonic probe and to equalize recorded amplitude responses for the second ultrasonic probe. The method may then proceed to repeat uniformization, TCG generation, and TCG normalization for the second ultrasonic probe, and the same sequence may be repeated for each additional probe in the system. This dual-purpose use of each set of reference reflectors may reduce the total number of axial zones and reference reflector sets required in the calibration body, simplifying its construction and reducing its overall length while still supporting full and independent calibration of each probe in a multi-probe system.

In certain embodiments, the method may further comprise detecting a peak amplitude response of a sensitivity reference reflector, which may be a surface notch formed in one of the four exterior surfaces of the calibration body at a location axially separate from the reference reflector sets, from one or more of the gain-corrected angle-beam ultrasonic pulses. A global gain offset may be computed to bring the detected peak amplitude response to a predetermined reference amplitude, and the global gain offset may be applied uniformly to all gain-corrected angle-beam ultrasonic pulses before proceeding to normalization. This global reference adjustment may set the absolute sensitivity of the inspection system to a consistent, predetermined baseline, compensating for day-to-day variations in system sensitivity that may not be captured by the relative beam-to-beam corrections applied.

In certain embodiments, the method may further comprise repositioning the calibration body from the beam uniformization position to the TCG generation position by rotating the calibration body about a longitudinal axis of the calibration body rather than, or in addition to, translating it along the longitudinal axis. By rotating the calibration body, the angular relationship between the reference reflectors and the ultrasonic probe may change such that the same set of reference reflectors that provided a substantially uniform-depth geometry in the beam uniformization position may now provide a varying-depth geometry in the TCG generation position. This may allow the method to be performed using a single set of reference reflectors for both beam uniformization and TCG generation, without requiring the calibration body to have multiple axial zones of reference reflectors.

In certain embodiments, the method may further comprise, prior to recording amplitude responses in the beam uniformization position, selecting a subset of the angle-beam ultrasonic pulses to be actively transmitted by the ultrasonic probe based on the cross-sectional dimension of the calibration body, such that angle-beam ultrasonic pulses whose paths would not intersect the calibration body are excluded from the calibration sequence. By performing this selective pulse deactivation before commencing beam uniformization, the entire calibration sequence may be performed using only the subset of pulses that will actually be active during subsequent inspection of a test workpiece of the corresponding cross-sectional dimension. This may improve the relevance and accuracy of the calibration data and may prevent pulses that do not intercept the workpiece from contributing spurious amplitude responses that could distort the beam uniformization corrections or the TCG curve.

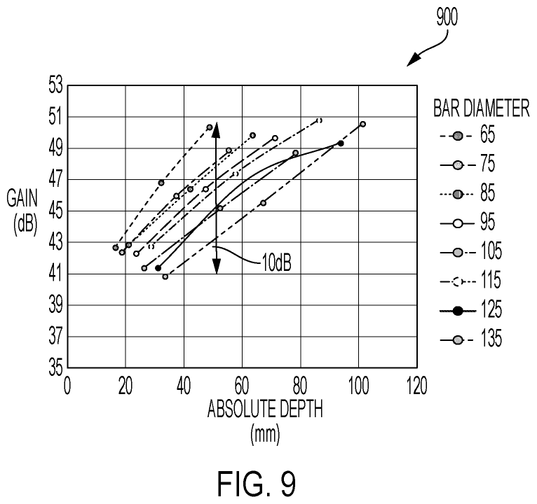

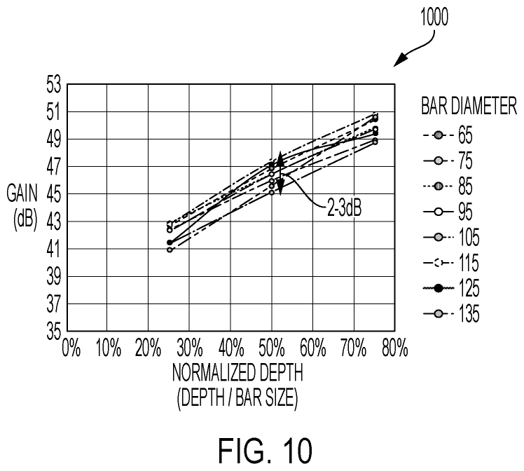

In one experimental example, the normalization approach of the present disclosure was validated using a phased-array ultrasonic inspection system of the type described herein. TCG curves were recorded for a series of calibration bodies (calibration bars) having cross-sectional dimensions ranging from approximately 65 mm to 135 mm, in increments of approximately 10 mm, using the calibration body and system described in this specification. The experimental results are presented in FIGS. 9 and 10 and discussed below.

Referring to FIG. 9, a chart 900 shows the TCG curves for all calibration body sizes in the tested range are shown plotted as gain in decibels as a function of absolute depth in millimeters. Each curve corresponds to a TCG curve G(d) generated for a respective calibration body size by piecewise linear interpolation between recorded (depth, gain) data points, where G(d) represents the gain required at absolute depth d to bring the peak amplitude response at that depth to a reference level. As illustrated in FIG. 9, when TCG curves are expressed in terms of absolute depth, the curves for different calibration body sizes diverge substantially. No two calibration body sizes share a common TCG curve when expressed in absolute depth terms. At any given absolute depth, for example, at approximately 50 mm, a span of up to approximately 10 dB in gain values may be observed across the range of calibration body sizes tested. This divergence confirms the challenge described above: a TCG curve G(d) generated for a calibration body of one cross-sectional dimension Dcal cannot be directly applied to workpieces of different sizes without significant error in gain compensation.

Referring to FIG. 10, the same TCG data are shown plotted as gain in decibels as a function of normalized depth, expressed as a percentage of the cross-sectional dimension of each respective calibration body. That is, for each calibration body of cross-sectional dimension Dcal, the TCG curve G(d) is converted to a normalized TCG curve G_norm(nd) by expressing each absolute depth d as a normalized depth nd=d/Dcal, such that G_norm(nd)=G(d), as described above. As illustrated in FIG. 10, when the depth axis is normalized in this manner, the TCG curves for all calibration body sizes in the tested range converge to a substantially common curve. At any given normalized depth, for example, at approximately 50% of the normalized depth, the span in gain values across all tested calibration body sizes is reduced to approximately 2 to 3 dB, compared to the span of up to approximately 10 dB observed in the absolute depth representation of FIG. 9. This convergence indicates that a single normalized TCG curve G_norm(nd) derived from one calibration body may be rescaled and applied to workpieces of different cross-sectional dimensions, as described above, without requiring a separate calibration for each workpiece size. This convergence to a substantially common normalized TCG curve is a significant and non-obvious result.

In the immersion-based inspection arrangement described herein, a change in the cross-sectional dimension of the workpiece under inspection affects not only the acoustic travel path within the workpiece material but also the acoustic travel path through the coupling medium (e.g., water) between the ultrasonic probe and the workpiece surface. Specifically, when the cross-sectional dimension of the workpiece decreases, the acoustic path length within the workpiece material decreases proportionally, but the acoustic path length through the coupling medium increases correspondingly, because the ultrasonic probe remains at a fixed position while the workpiece surface recedes. These two path-length changes act in opposing directions: the shorter material path tends to reduce depth-dependent attenuation, while the longer coupling medium path introduces additional attenuation and acoustic effects that do not scale with the cross-sectional dimension of the workpiece in the same manner. It is therefore not self-evident that expressing the TCG curve as gain as a function of normalized depth, that is, depth expressed as a fraction or percentage of the cross-sectional dimension of the workpiece, would yield a substantially common normalized TCG curve across different workpiece sizes, because the gain at any given normalized depth reflects the combined acoustic effects of both the material path and the coupling medium path, which vary inversely with respect to one another as workpiece

### Size Changes.

The experimental results of FIGS. 9 and 10 can demonstrate that, notwithstanding these competing acoustic path effects, the normalization approach of the present disclosure can produce a substantially common normalized TCG curve that is applicable across the tested range of calibration body sizes. The normalized TCG curve may then be rescaled for any specific test workpiece size by multiplying the normalized depth values by the cross-sectional dimension of the test workpiece, as described above, producing an accurate depth-dependent gain compensation curve for that workpiece without requiring a separate calibration procedure.

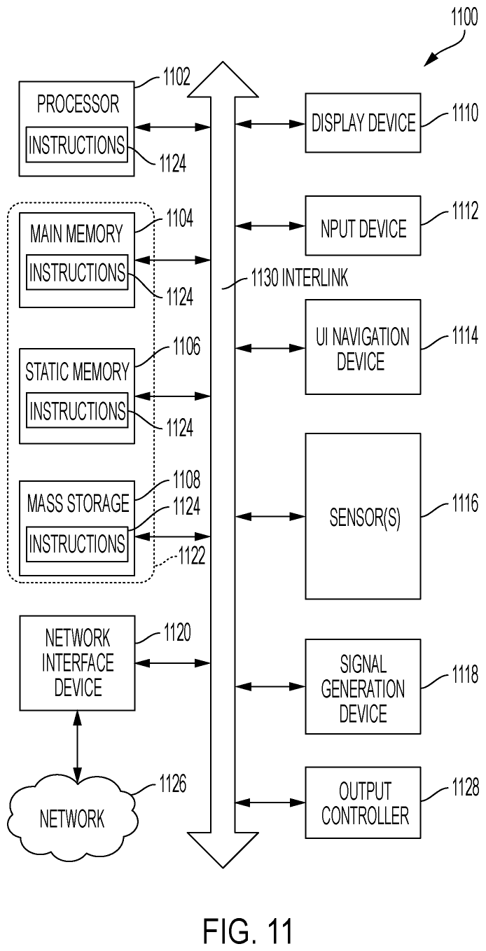

FIG. 11 illustrates a block diagram of an example comprising a machine 1100 upon which any one or more of the techniques (e.g., methodologies) discussed herein may be performed. In various embodiments, the machine may implement the control circuit described with respect to FIG. 1, the control circuit described with respect to FIG. 5, and/or the control circuit described with respect to FIGS. 6A-6C, and may perform the method described with respect to FIG. 8, including beam uniformization, TCG generation, normalization, rescaling, reference adjustment, and inspection operations described herein. The machine (e.g., computer system) may include a hardware processor 1102 (e.g., a central processing unit (CPU), a graphics processing unit (GPU), a hardware processor core, or any combination thereof), a main memory 1104 and a static memory 1106, connected via an interlink 1130 (e.g., link or bus), as some or all of these components may constitute hardware for systems or related implementations discussed above.

Generally, the hardware processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. One or more such hardware processors may implement the one or more processors of the control circuit and may execute machine-readable instructions to perform beam uniformization, TCG generation, TCG normalization, TCG rescaling, reference adjustment, beam selection, and inspection operations as described herein. A processor circuit may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor circuit may be emulated in software, running on a physical processor as a virtual processor or virtual circuit. The virtual processor may behave like an independent processor but is implemented in software rather than hardware.

Specific examples of main memory include Random Access Memory (RAM) and semiconductor memory devices, which may include storage locations in semiconductors such as registers. Specific examples of static memory include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks. The main memory 1104 and/or static memory 1106 may implement the one or more memory circuits 134 of the control circuit and may store calibration data including per-beam uniformization tables, TCG curves, normalized TCG curves, normalized breakpoint tables, global gain offsets, beam selection parameters, and bar size information as described herein.

The machine may further include a display device 1110, an input device 1112 (e.g., a keyboard), and a user interface (UI) navigation device 1114 (e.g., a mouse). In an example, the display device, input device, and UI navigation device may be a touch-screen display. The machine may include a mass storage device 1108 (e.g., drive unit), a signal generation device 1118 (e.g., a speaker), a network interface device 1120, and one or more sensors 1116, such as a global positioning system (GPS) sensor, compass, accelerometer, or some other sensor. The machine may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). The display device 1110 may implement the display 136 of the control circuit 130 for presentation of calibration results, inspection data, TCG curves, and alarm indications. The input device 1112 and/or the UI navigation device 1114 may implement the one or more input devices of the control circuit for receiving operator commands, bar size information, calibration parameters, and inspection setup configurations.

The mass storage device may comprise a machine-readable medium 1122 on which is stored one or more sets of data structures or instructions 1124 (e.g., software) embodying or utilized by any one or more of the techniques or functions described herein. The instructions may also reside, completely or at least partially, within the main memory, within static memory, or within the hardware processor during execution thereof by the machine. In an example, one or any combination of the hardware processor, the main memory, the static memory, or the mass storage device comprises a machine-readable medium.

Specific examples of machine-readable media include one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions.

An apparatus of the machine includes one or more of a hardware processor (e.g., a central processing unit (CPU), a graphics processing unit (GPU), a hardware processor core, or any combination thereof), a main memory and a static memory, sensors, a network interface device, antennas, a display device, an input device, a UI navigation device, a mass storage device, instructions, a signal generation device, or an output controller. The apparatus may be configured to perform one or more of the methods or operations disclosed herein.

The term “machine readable medium” includes, for example, any medium that is capable of storing, encoding, or carrying instructions for execution by the machine and that cause the machine to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions may be transmitted or received, for example, over a communications network using a transmission medium via the network interface device utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®), a IEEE 802.15.4 family of standards, a Long Term Evolution (LTE) 4G or 5G family of standards, a Universal Mobile Telecommunications System (UMTS) family of standards, peer-to-peer (P2P) networks, and satellite communication networks, among others. In various embodiments, the control circuit may communicate inspection results, calibration data, normalized TCG curves, accept/reject determinations, or calibration status information to a production line control system, a machine controller, a supervisory system, or a remote compute facility via such communications networks.

In an example, the network interface device includes one or more physical jacks (e.g., Ethernet, coaxial, or other interconnection) or one or more antennas to access the communications network. In an example, the network interface device includes one or more antennas to wirelessly communicate using at least one of single-input multiple-output (SIMO), multiple-input multiple-output (MIMO), or multiple-input single-output (MISO) techniques. In some examples, the network interface device wirelessly communicates using Multiple User MIMO techniques. The term “transmission medium” shall be taken to include any intangible medium that is capable of storing, encoding or carrying instructions for execution by the machine, and includes digital or analog communication signals or any other intangible medium able to facilitate communication of such software.

The terms “control circuit” and “controller” are substitutable with each other and encompass hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may be part of larger systems, such as integrated circuits (ICs), application-specific integrated circuits (ASICs), or systems-on-chips (SoCs), and may be found in devices such as computers, smartphones, wearable devices, and servers. These circuits may perform tasks involving data processing, communication, or data storage. Depicted components, functions, or operations may be implemented using hardware, software, firmware, or combinations of two or more thereof.

Instructions for implementing system features may be stored in various types of memory. Suitable memory may include dynamic random-access memory (DRAM), flash memory, and/or cache. These instructions may be distributed over a network or via other computer-readable media. The term “non-transitory computer-readable medium” refers to any physical medium capable of storing instructions or information that may be read by a machine. Examples of suitable non-transitory media include RAM, ROM, EPROM, EEPROM, magnetic or optical media, and flash memory.

In some embodiments, the control circuit may utilize machine learning (ML) techniques to make decisions based on sensor inputs or other data. Suitable ML methods may include supervised learning (with labeled inputs and outputs), unsupervised learning (for identifying patterns), or reinforcement learning (where the system adapts based on feedback). Suitable tasks for ML systems may involve classification, regression, clustering, anomaly detection, or optimization. ML may employ algorithms, such as decision trees, deep learning, support vector machines (SVMs), or neural networks, depending on the application. In the context of the ultrasonic inspection system disclosed herein, the control circuit may employ ML techniques for one or more of: optimizing beam selection based on bar cross-sectional size; identifying peak amplitude responses from echo signals during beam uniformization or TCG generation; fitting or smoothing TCG curves from recorded amplitude-depth data pairs; detecting anomalies in calibration data indicative of probe degradation, coupling inconsistencies, or reference reflector damage; classifying or characterizing detected flaws during production inspection; and making accept/reject determinations for bars under inspection. A suitable control circuit may incorporate a policy engine that applies specific rules based on equipment characteristics or environmental conditions. For instance, a neural network could process sensor data or operational inputs to determine appropriate actions. Techniques such as backpropagation or evolutionary strategies may be used to refine neural network parameters and optimize model selection for the given task.

In one embodiment, the control circuit (or controller) and system described herein may use machine learning to make determinations and to enable derivation-based learning outcomes. The system may communicate with a data collection system. The control circuit may learn from, model and make decisions/determinations on a set of data (including data provided by various sensors and data collection systems) by making data-driven predictions and adapting according to available data and modeling.

Machine learning may involve performing tasks using supervised learning, unsupervised learning, and reinforcement learning systems. Supervised learning may use one or more sets of example inputs and desired outputs with the machine learning systems, where unsupervised learning may use a learning algorithm that is structuring its input with, for example, pattern detection and/or feature learning. Reinforcement learning may perform in a dynamic environment and then provide feedback about correct and incorrect decisions. Machine learning may include tasks based on certain outputs. These tasks may be machine learning problems that can be addressed using mathematical and statistical techniques such as classification, regression, clustering, density estimation, dimensionality reduction, anomaly detection, and the like.

Suitable machine learning algorithmic types may include decision tree based learning, association rule learning, deep learning, artificial neural networks, genetic learning algorithms, inductive logic programming, support vector machines (SVMs), Bayesian networks, reinforcement learning, representation learning, rule-based machine learning, sparse dictionary learning, similarity and metric learning, learning classifier systems (LCS), logistic regression, random forest algorithms, K-means algorithms, gradient boost algorithms, K-nearest neighbors (KNN) algorithms, a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components are restricted to being integer-valued. Algorithms and machine learning techniques and systems may be used in computational intelligence systems, computer vision, Natural Language Processing (NLP), recommender systems, reinforcement learning, graphical models, and the like. In an example, machine learning may be used to perform determinations, calculations, comparisons and behavior analytics, and the like.

As mentioned above, the control circuit may include a policy engine. The policies the engine may apply may be based at least in part on characteristics of a given item of equipment or environment. For example, an artificial intelligence system, such as a neural network, may receive a number of environmental and task-related parameters as inputs. These parameters may include, for example, operational input of a given piece of equipment, data from various sensors, environmental information, location and/or position data, and the like. In the context of the ultrasonic inspection system disclosed herein, such parameters may include bar cross-sectional size, probe configuration data, coupling medium characteristics, echo signal data, calibration state information, and production line parameters. The neural network may be trained and may generate an output based on these inputs, with the output representing an action or sequence of actions that the equipment or system should take to accomplish the goal of the operation. Using a specific set of model parameters, the control circuit facilitates the propagation of the inputs through the neural network in order to generate one or more values (e.g., make a determination) at the output node(s); these values allow the model to correctly select the desired action, activity, or operating state. An action may translate into a signal that causes the ultrasonic inspection system to operate in a particular manner, such as adjusting gain parameters, selecting active beams, initiating a calibration sequence, or generating an accept/reject determination for a bar under inspection. The control circuit may accomplish this via backpropagation, feed forward processes, closed loop feedback, or open loop feedback, for example. Alternatively, rather than using backpropagation, the control circuit may rely on a class of techniques known as evolution strategies to tune various parameters in the neural network. The control circuit may use neural network architectures that have a set of parameters representing weights that are applied to the various node connections. A number of copies of this network may be generated and adjustments to the parameters may be made with subsequent simulations. Once the outputs from the various models have been obtained, they may be evaluated on their performance using one or more success metrics. The best model or a “good enough” model may be selected, and the control circuit may execute that plan to achieve the desired input data to mirror the predicted ‘best outcome’ scenario. Additionally, the success metric itself may be a combination of the optimized outcomes, which may be weighted relative to each other. Success metrics may be dynamically established, and the process rerun and the equipment directions further modified.

In one embodiment, data may be generated, transmitted, and stored and may involve one or both of a protected space data source and an exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), and/or switch equipment or control operations to a safe mode of the control system, and/or initiate a safe mode state of the equipment (e.g., slow a vehicle to a safe and controlled stop). The safe mode may be, in one embodiment, a soft shutdown mode that is intended to avoid damage or injury based on the shutdown itself and in another embodiment may be a reboot and/or minimal reload of essential drivers and functionality.

Terms such as “processing,” “computing,” “calculating,” or “determining” refer to operations carried out by the control circuit, which may include computing systems or electronic devices that manipulate data represented as physical (electronic) quantities within memory or registers. One or more components may be described as “configured to,” “configurable to,” “operable/operative to,” “adapted/adaptable to,” or similar terms. Unless explicitly stated, these terms encompass components in both active and inactive states.

As used herein, the term “substantially” can refer to a condition that is sufficiently close to a stated condition so as to achieve the same functional result. The degree of deviation from the stated condition that is permissible may depend on the specific context. In general, “substantially” can encompass variations that would be recognized by a person of ordinary skill in the art as being functionally equivalent to the stated condition. For example, “substantially equalize” can mean to bring a set of values sufficiently close to a common level such that any residual differences among the values do not materially affect the intended technical result, and “substantially uniform” can mean sufficiently uniform so as to achieve the intended technical effect, even if minor non-uniformities exist. Depending on the context, “substantially” may encompass deviations of up to 1%, 5%, 10%, 15%, 20%, or 25% from a stated value or condition, where the permissible degree of deviation is that which a person of ordinary skill in the art would consider to be functionally equivalent to the stated value or condition for the particular application.

As used herein, the terms “about” and “approximately” can be used interchangeably and can refer to a value or condition that is close to the stated value or condition. Unless otherwise indicated or apparent from the context, “about” or “approximately” may encompass a range of variation of up to 1%, 5%, 10%, 15%, 20%, or 25% from the stated value, where the permissible degree of variation is that which a person of ordinary skill in the art would consider to be functionally equivalent to the stated value for the particular application. The use of “about” or “approximately” in connection with a numerical value is intended to include the stated value itself.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in a claim are still deemed to fall within the scope of that claim. Moreover, in the following aspects, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following aspects are hereby incorporated into the Detailed Description as examples or embodiments, with each aspect standing on its own as a separate embodiment, and it is contemplated that such embodiments can be combined with each other in various combinations or permutations.

What is claimed is:

1. An ultrasonic inspection system for inspecting workpieces having different cross-sectional dimensions, the system comprising:
an ultrasonic probe operable to transmit a plurality of angle-beam ultrasonic pulses toward a workpiece and receive reflected pulse signals;
a calibration body including a plurality of reference reflectors, where the calibration body is positionable relative to the ultrasonic probe such that respective pulses of the plurality of angle-beam ultrasonic pulses intersect corresponding reference reflectors along different acoustic travel paths within the calibration body; and
a control circuit operatively coupled to the ultrasonic probe, the control circuit configured to:
receive ultrasonic responses corresponding to reflected pulse signals from the reference reflectors;
generate a time-compensated gain (TCG) curve by aggregating amplitude responses of the ultrasonic responses with corresponding acoustic travel depths;
normalize the TCG curve based on a cross-sectional dimension of the calibration body to produce a normalized TCG curve; and
apply the normalized TCG curve to inspection of a test workpiece having a cross-sectional dimension different from that of the calibration body by rescaling the normalized depth in proportion to the cross-sectional dimension of the test workpiece to determine a gain value applied during inspection.

2. The system of claim 1, wherein the positioning of the calibration body relative to the ultrasonic probe such that respective pulses of the angle-beam ultrasonic pulses intersect corresponding reference reflectors along different acoustic travel paths defines a TCG generation position, and the calibration body is further positionable relative to the ultrasonic probe in a beam uniformization position in which different angle-beam ultrasonic pulses intersect respective reference reflectors at substantially uniform depths within the calibration body, and wherein the control circuit is further configured to:
prior to generating the TCG curve, determine gain corrections to substantially equalize amplitude responses across the plurality of angle-beam ultrasonic pulses recorded with the reference reflectors arranged in the beam uniformization position.

3. The system of claim 2, further comprising a plurality of ultrasonic probes, wherein the calibration body comprises four exterior surfaces and is positionable with each of the four exterior surfaces facing a respective probe of the plurality of ultrasonic probes, and wherein the control circuit is operatively coupled to each of the plurality of ultrasonic probes and is configured to independently generate and normalize a TCG curve for each of the plurality of ultrasonic probes.

4. The system of claim 3, wherein the reference reflectors are organized into a plurality of sets comprising at least a first set, a second set, a third set, and a fourth set, each set corresponding to a respective exterior surface of the four exterior surfaces of the calibration body and each set being located at a respective distinct axial zone along a longitudinal axis of the calibration body.

5. The system of claim 4, further comprising a motorized linear drive configured to translate the calibration body along the longitudinal axis relative to the plurality of ultrasonic probes, wherein the motorized linear drive is operable to selectively align the axial zones of the calibration body with the plurality of ultrasonic probes such that each set of reference reflectors is positionable in the TCG generation position and the beam uniformization position for a respective probe of the ultrasonic probes.

6. The system of claim 1, wherein the reference reflectors are holes formed within an interior of the calibration body.

7. The system of claim 6, wherein each hole extends within the calibration body along an axis oriented at an angle relative to a longitudinal axis of the calibration body such that relative axial movement between the calibration body and the ultrasonic probe causes an effective lateral position of each hole, as intersected by a respective pulse of the plurality of angle-beam ultrasonic pulses, to shift progressively, enabling each respective pulse to achieve alignment with a center of an intersected hole to record a peak amplitude response.

8. The system of claim 1, wherein the calibration body further comprises a sensitivity reference reflector, and wherein the control circuit is further configured to perform a reference adjustment operation comprising receiving a peak amplitude response of the sensitivity reference reflector recorded by one or more of the angle-beam ultrasonic pulses, computing a global gain offset to bring the peak amplitude response to a predetermined reference amplitude, and applying the global gain offset to each of the plurality of angle-beam ultrasonic pulses.

9. The system of claim 1, wherein the control circuit is further configured to adjust a number of the angle-beam ultrasonic pulses actively transmitted by the ultrasonic probe based on the cross-sectional dimension of the test workpiece, such that pulses of the plurality of angle-beam ultrasonic pulses whose paths would not intersect the test workpiece are deactivated.

10. The system of claim 1, wherein the ultrasonic probe is a phased-array ultrasonic probe and the plurality of angle-beam ultrasonic pulses are configured to be transmitted at an angle relative to an exterior surface of the calibration body, and wherein the calibration body and the ultrasonic probe are in acoustic contact through a coupling medium comprising water.

11. A method of calibrating an angle-beam ultrasonic inspection system for inspecting workpieces having different cross-sectional dimensions, the method comprising:
positioning a calibration body in a beam uniformization position relative to an ultrasonic probe such that reference reflectors within the calibration body are at a substantially uniform distance from an active region of the ultrasonic probe;
recording, for each of a plurality of angle-beam ultrasonic pulses emitted by the ultrasonic probe, a peak amplitude response from a corresponding reference reflector of the calibration body;
determining gain corrections to substantially equalize the recorded peak amplitude responses across the plurality of angle-beam ultrasonic pulses;
positioning the calibration body in a Time Compensated Gain (TCG) generation position relative to the ultrasonic probe such that respective pulses of the angle-beam ultrasonic pulses, as gain-corrected, intersect corresponding reference reflectors along different acoustic travel paths within the calibration body;
recording, for each gain-corrected angle-beam ultrasonic pulse, a peak amplitude response from the corresponding reference reflector at an acoustic travel depth corresponding to the acoustic travel path of that pulse within the calibration body;
generating a TCG curve by aggregating the recorded peak amplitude responses with the corresponding acoustic travel depths; and
normalizing the TCG curve relative to a cross-sectional dimension of the calibration body to produce a normalized TCG curve, wherein the normalized TCG curve is applicable to inspection of a test workpiece having a cross-sectional dimension different from the cross-sectional dimension of the calibration body by rescaling the normalized depth in proportion to the cross-sectional dimension of the test workpiece to determine a gain value applied during inspection.

12. The method of claim 11, wherein the calibration body comprises at least a first set of reference reflectors located at a first axial zone along a longitudinal axis of the calibration body and a second set of reference reflectors located at a second axial zone along the longitudinal axis distinct from the first axial zone, the method further comprising translating the calibration body along the longitudinal axis to move the calibration body from the beam uniformization position to the TCG generation position, wherein the first set of reference reflectors is used in the beam uniformization position and the second set of reference reflectors is used in the TCG generation position.

13. The method of claim 12, wherein the ultrasonic probe is a first ultrasonic probe, the method further comprising:
positioning the calibration body such that the second set of reference reflectors is in the beam uniformization position relative to a second ultrasonic probe;
recording, for each of a plurality of angle-beam ultrasonic pulses emitted by the second ultrasonic probe, a peak amplitude response from a corresponding reference reflector of the second set of reference reflectors; and
determining gain corrections to substantially equalize the recorded peak amplitude responses across the plurality of angle-beam ultrasonic pulses of the second ultrasonic probe, the second set of reference reflectors thereby serving both to generate the TCG curve for the first ultrasonic probe and to equalize recorded peak amplitude responses for the second ultrasonic probe.

14. The method of claim 11, further comprising detecting a peak amplitude response of a sensitivity reference reflector from one or more of the gain-corrected angle-beam ultrasonic pulses, computing a global gain offset to bring the peak amplitude response to a predetermined reference amplitude, and applying the global gain offset to all gain-corrected angle-beam ultrasonic pulses.

15. The method of claim 11, further comprising repositioning the calibration body from the beam uniformization position to the TCG generation position by rotating the calibration body about a longitudinal axis of the calibration body.

16. The method of claim 11, further comprising, prior to recording amplitude responses in the beam uniformization position, selecting a subset of the angle-beam ultrasonic pulses to be actively transmitted by the ultrasonic probe based on the cross-sectional dimension of the calibration body, such that angle-beam ultrasonic pulses whose paths would not intersect the calibration body are excluded.

17. A calibration body for use with an angle-beam ultrasonic inspection system, the calibration body comprising:
a plurality of exterior surfaces;
a first set of reference reflectors formed within the calibration body at a substantially uniform depth below a first exterior surface of the plurality of exterior surfaces, each reference reflector of the first set being a hole extending within the calibration body along an axis oriented at an angle relative to a longitudinal axis of the calibration body, wherein the first set of reference reflectors is located in a first axial zone along the longitudinal axis; and
a second set of reference reflectors formed within the calibration body at a substantially uniform depth below a second exterior surface of the plurality of exterior surfaces, each reference reflector of the second set being a hole extending within the calibration body along an axis oriented at an angle relative to the longitudinal axis, wherein the second set of reference reflectors is located in a second axial zone along the longitudinal axis distinct from the first axial zone.

18. The calibration body of claim 17, further comprising a third set and a fourth set of reference reflectors, each reference reflector of the third set and fourth set being formed at a substantially uniform depth below a corresponding one of the remaining exterior surfaces of the plurality of exterior surfaces, each reference reflector of the third set and the fourth set being a hole extending within the calibration body along a respective axis oriented at an angle relative to the longitudinal axis, wherein the third set of reference reflectors is located in a third axial zone and the fourth set of reference reflectors is located in a fourth axial zone along the longitudinal axis, each of the first, second, third, and fourth axial zones being distinct from one another.

19. The calibration body of claim 17, wherein the first set and the second set of reference reflectors are substantially identical in configuration, with the first set and second set of reference reflectors differing only in their respective positions along the longitudinal axis and their respective exterior surfaces.

20. The calibration body of claim 17, further comprising a sensitivity reference reflector formed in the calibration body at a location distinct from the first axial zone and the second axial zone along the longitudinal axis, wherein the sensitivity reference reflector is a surface notch formed in one of the plurality of exterior surfaces.
